(19) United States
(12) Patent Application Publication
(10) Pub. No.: US 2026/0112669 A1
(43) Pub. Date: Apr. 23, 2026

(54) METHOD TO CAPTURE, STORE, AND RETRIEVE SYSTEM CONFIGURATION INFORMATION FROM AN I/O MODULE CONNECTED TO A FIELDBUS

(71) Applicant: Bloom Energy Corporation, San Jose, CA (US)

(72) Inventors: Archana BHALERAO, Pleasanton, CA (US); Peter G. ANDERSEN, Pella, IA (US); Jignesh Francis LAWRANCE, Newark, DE (US); Thomas D. SCHER-CARRIKER, Newark, DE (US); Anilkumar VISHNUVARJULA, Bangalore (IN); Beau E. BAKER, Sunnyvale, CA (US); Vishal Anand GOPALAKRISHNAN, Bangalore (IN)

(21) Appl. No.: 19/359,074

(22) Filed: Oct. 15, 2025

Related U.S. Application Data
(60) Provisional application No. 63/708,936, filed on Oct. 18, 2024.

(51) Int. Cl. H01M 8/04858; H01M 8/04537; H04L 12/40

(52) U.S. Cl. CPC H01M 8/0494; H01M 8/04552; H04L 12/40; H04L 2012/4026

(57) ABSTRACT

A method for configuring an electrochemical cell system. Embodiments may include a balance of plant functional tester configured to retrieve a fuel cell module (FCM) configuration based on an identifier of a FCM and provide the FCM configuration to a module voltage input/output (MVIO) module of the FCM via a fieldbus message. Embodiments may also include storing the FCM configuration on a memory of the MVIO module and providing it to an electrochemical cell system controller.

### FIELD

The present disclosure is directed to electrochemical cell systems, such as fuel cell and elecrolyzer cell systems, and to storing and retrieving configurations of the systems for individual deployments.

### BACKGROUND

Electrochemical cell systems include fuel cell and electrolyzer cell systems, such as solid oxide fuel cell and electrolyzer cell systems. Different versions of these systems are installed in the field and monitored and controlled from a remote central control location. Wireless or wired control system connections provide data between one or more controllers located at the system deployment site and computer systems located at the central control location.

### SUMMARY

Various embodiments may include methods and systems for capturing, storing, and retrieving system and site-specific configuration information for an electrochemical cell module (also referred to as a fuel cell module or FCM). The configuration information may be automatically captured during manufacturing or site commissioning and stored in memory within a Module Voltage Input/Output (MVIO) module. The MVIO module communicates with a system controller over a local fieldbus, such as a Controller Area Network (CAN) bus, and allows the system controller to retrieve and apply the correct operating parameters without requiring manual entry of configuration data. Various embodiments provide redundancy features that allow configuration data to be preserved and transferred if either the MVIO module or the system controller is replaced. Some embodiments include methods for storing site-specific settings, such as those needed to meet utility requirements, further reducing the possibility of human error and ensuring seamless integration with utility grids. The automated approach of the various embodiments may improve system reliability, reduce operator workload, and mitigate the risks associated with implementing an incorrect configuration during system setup.

### BRIEF DESCRIPTION OF DRAWINGS

The accompanying drawings, which are incorporated herein and constitute part of this specification, illustrate exemplary embodiments of the claims, and together with the general description given and the detailed description, serve to explain the features herein.

FIG. 1 is a perspective view of an electrochemical cell system suitable for implementing various embodiments.

FIG. 2 is a schematic side cross-sectional view of a hot box suitable for implementing various embodiments.

FIG. 3 is a component block diagram of an electrochemical cell system controller suitable for implementing various embodiments.

FIG. 4 is a component block diagram of a MVIO module configuration system suitable for implementing various embodiments.

FIG. 5 is a component block diagram of an FCM configuration system suitable for implementing various embodiments.

FIG. 6 is a component block and signaling diagram of a MVIO module configuration system suitable for implementing various embodiments.

FIG. 7 is a process flow diagram of a method for configuring a MVIO module according to various embodiments.

FIGS. 8A and 8B are component block and signaling diagrams of a FCM controller configuration system suitable for implementing various embodiments.

FIGS. 9A-9C are process flow diagrams of a method for configuring a FCM controller according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims. As used herein, the terms “electric energy” and “electric energy output” refer to amounts of electric voltage, current, or power. Examples herein described in terms of voltage do not limit the scope of the claims and descriptions to such types of electric energy and electric energy output.

Different electrochemical cell systems (e.g., different fuel cell systems or different electrolyzer cell systems) have different configurations (e.g., different components and/or different operating parameters) from each other. In order to provide correct operating instructions from the central control location to various systems deployed at different deployment sites, the operator and/or the central controller located at the central control location must know the specific configuration of the electrochemical cell system at each deployment site. Since different FCMs and systems are often located in similar looking cabinets, even the installation personnel at a particular deployment site may not comprehend the complete configuration of the system being installed at the deployment site. Furthermore, an operator at the central control location is typically located far from the deployment site, and thus, does not have full visibility into the configuration of the systems.

System controllers typically do not have the ability to query databases and obtain system configuration information automatically. To obtain system configuration information, operators manually configure the system, such as by looking up configuration information in external databases and entering the configuration information manually into the system controllers through a Human Machine Interface (HMI). This process is prone to human errors and increases not only the operator time and effort but also the risk of damaging the FCMs due to incorrect operating parameters.

Each deployment site has site-specific settings for the electrochemical cell modules or FCMs that are required to meet utility requirements. If the settings are incorrect, the electrochemical cell modules or FCMs will not be able to connect to the utility grid and, in some cases can result in heavy utility penalties for the operator. Keeping track of all these settings and manually entering them into the controller through the HMI is a very laborious process and prone to human errors.

Various embodiments include electrical circuits, electrical components, and methods for configuring a MVIO module for a FCM. In some embodiments, a balance of plant (BOP) functional tester and a MVIO module may be connected via a controller area network (CAN) bus. Throughout this disclosure, reference is made to a CAN bus, but the disclosure is not limited to that communication network technology. Any local fieldbus constituting a private, industrial control oriented communication method may be utilized. The BOP functional tester may be configured to retrieve configuration data of the FCM based on an identifier for the FCM and send the configuration data to the MVIO module via the CAN bus to be written to a memory on the MVIO module.

Various embodiments include electrical circuits, electrical components, and methods for configuring a system controller of an electrochemical cell system. In some embodiments, the MVIO module of the FCMFCM of the electrochemical cell system and the system controller of the electrochemical cell system may be connected via a CAN bus. The system controller may be configured to retrieve configuration data of the FCMFCM from the MVIO module via the CAN bus to be loaded to the system controller.

One manner of configuring the FCMs includes storing configuration information in remote databases and querying the remote databases to obtain the configuration information. But this solution needs connectivity to external networks which can cause security concerns. This is not a workable solution for electrochemical cell systems that are isolated from external networks and cannot access or query any remote databases.

Various embodiments include methods, and devices configured to implement the methods, for configuring the electrochemical cell system, including configuring the MVIO module with configuration data for a FCM and configuring the system controller of the electrochemical cell system with configuration data for the FCM from the MVIO module. The embodiments enable the configuration of the electrochemical cell system with the configuration data for the FCM while reducing the possibilities of human error and security risks of being connected to external networks. The embodiments eliminate the manual process of the operator obtaining the system configuration information or the site-specific settings from remote sources and inputting them into the system controller through the HMI. The embodiments may include automatically capturing and storing the configuration data for a FCM into a MVIO module via a CAN bus during a manufacturing process or a site configuration process. During a site or electrochemical cell system startup, the configuration data for the FCM stored in the MVIO module may be read by the electrochemical cell system controller via a CAN bus connection and used to operate the site or the electrochemical cell system.

Each FCM may go through a BOP functional tester during the manufacturing process. The BOP functional tester may communicate with the MVIO module over the CAN bus to transmit data. The BOP functional tester may be configured to execute software, such as a LabVIEW-based application, to use an identifier of the FCM, such as a top level stack enclosure module (SKE) part number or another part number of the FCM, to automatically retrieve and transmit to the MVIO module the configuration data for the FCM. In some embodiments, the BOP functional tester may be configured to execute the software to implement error handling to ensure that correct configuration data for the FCM is captured and stored in the MVIO module. In some embodiments, the BOP functional tester may be configured to execute the software to implement verification of the configuration data for the FCM. For example, verification may be implemented during a final inspection step of the manufacturing process, during which the configuration data for the FCM stored in the MVIO module is verified and updated if needed. The embodiments may ensure that every FCM that is deployed from manufacturing is shipped with the MVIO module having stored the configuration data for the FCM. FCM configuration data stored in the MVIO module can include relevant assembly drawing numbers, unit serial numbers, re-work numbers, the manufacturing location for the FCM, fuel cell configurations within in the FCM (e.g., number of stacks in a column, types of interconnects used in the stacks, whether the stacks are for SOFC or SOEC applications, etc.), variations in hot-box hardware configurations (e.g., anode tail gas oxidizer designs, identification of which blowers are present), and any other information that would be useful to know for monitoring and servicing the FCM over the course of its intended operational life.

For the FCM installed in the electrochemical cell system and powered up, the system controller of the electrochemical cell system may communication with the MVIO module over a CAN bus and read the configuration data for the FCM stored in the MVIO module. In some embodiments, the system controller may read the messages from the MVIO module and load the configuration data for the FCM and display configuration data on the HMI. The system controller may load the configuration data for the FCM to apply correct operating parameters and control logic features and to ensure that the FCM is operated correctly. In some embodiments, the operator of the electrochemical cell system may make changes to calibration data if any components are replaced in the field. The calibration data may be written from the system controller and stored on the MVIO module via messages transmitted over the CAN bus.

Various embodiments provide a significant advantage in redundancy in the storage of the configuration data for the FCM. If, for any reason an MVIO module is replaced in the field, the system controller of the electrochemical cell system may copy the configuration data for the FCM stored in the MVIO module. Then, when the new MVIO module is installed in the FCM, the system controller can transmit and store the copied configuration information into the new MVIO module. Similarly, if the system controller is replaced in the field, a new system controller may establish communication with the MVIO module over the CAN bus, read the stored configuration data for the FCM, and apply it automatically. This redundancy ensures that the system configuration can be preserved in the event of hardware replacements, minimizing downtime and reducing the risk of configuration errors.

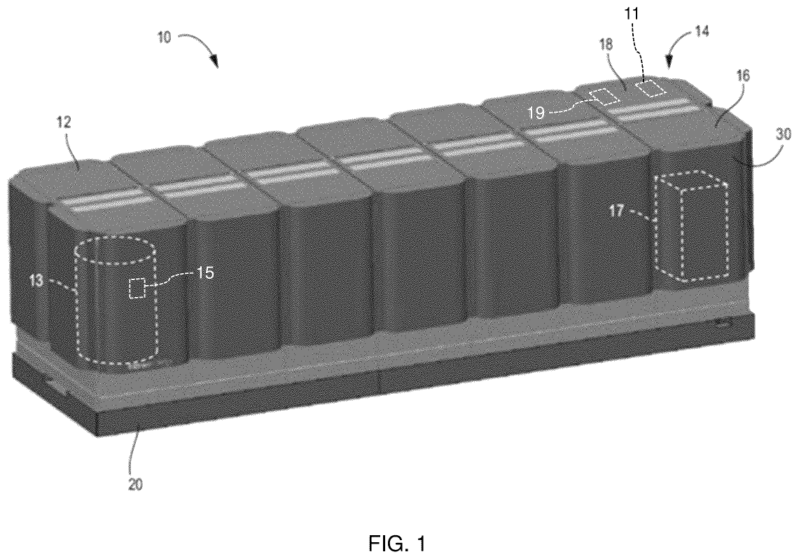

FIG. 1 illustrates an example of a modular electrochemical cell system, such as a modular fuel cell system, which is more fully described in U.S. Pat. No. 8,440,362, incorporated herein by reference for descriptions of the modular electrochemical cell system. The modular system may contain modules and components described above as well as in U.S. Pat. No. 9,190,693, which is incorporated herein by reference for descriptions of the modular electrochemical cell system. The modular design of the electrochemical cell system enclosure 10 provides options for flexible system installation and operation.

The modular electrochemical cell system enclosure 10 includes a plurality of power module housings (i.e., cabinets) 12, one or more fuel input (i.e., fuel processing) module housings 16, and one or more power conditioning (i.e., electrical input and/or output) module housings 18. For example, the system enclosure may include any desired number of modules, such as 2-30 power modules, for example 6-12 power modules. FIG. 1 illustrates a system enclosure 10 containing twelve power modules or FCMs (two rows of six modules stacked side to side), one fuel processing module, and one power conditioning module, all on a common base 20. Each module may comprise its own cabinet or housing. Alternatively, the power conditioning and fuel processing modules may be combined into a single input/output module located in one cabinet or housing 14.

Each power module housing 12 is configured to house one or more FCMs 13 (FCMs 13). The FCM 13 may comprise a hotbox which contains one or more stacks or columns of electrochemical cells separated by interconnects. The electrochemical cells may comprise fuel cells, such as solid oxide fuel cells, or electrolyzer cells, such as solid oxide electrolyzer cells. Other electrochemical cell types, such as proton exchange membrane (PEM), molten carbonate, phosphoric acid, etc. may also be used. The FCM 13 may also include balance of plant (BOP) components, such as blowers, valves, detectors (e.g., flow meters, current and/or voltage sensors, temperature sensors, etc.), etc.

The FCM 13 also includes a MVIO module 15 configured to measure electrical signals from sensors (not shown) that output a voltage and convert the electrical signals to digital signals. The MVIO module 15 may be configured to communicate with a controller, such as a system controller 19 (which may be located in the power conditioning module housing 18), sending and receiving digital signals via a wired or wireless communication network channel 11, including digital signals transmitted over a CAN bus or digital signals transmitted over a wireless network (e.g., Wi-Fi) combined with a wireless CAN bus bridge that connects a physical CAN bus via a wireless radio network.

The modular electrochemical cell system enclosure 10 also contains one or more input or fuel processing module housings 16. For fuel cell systems, the fuel processing module housing 16 includes a cabinet that contains the components used for pre-processing of fuel, such as desulfurizer beds. The fuel processing module housings 16 may be designed to process different types of fuel. For example, a hydrogen fuel processing module, a natural gas fuel processing module, an ethanol fuel processing module, and/or an ammonia fuel processing module may be provided in the same or in separate cabinets. A different bed composition tailored for a particular fuel may be provided in each module housing. The processing module housing 16 may process at least one of the following fuels selected from natural gas provided from a pipeline, compressed natural gas, methane, propane, liquid petroleum gas, gasoline, diesel, home heating oil, kerosene, JP-5, JP-8, aviation fuel, hydrogen, ammonia, ethanol, methanol, syn-gas, bio-gas, bio-diesel and other suitable hydrocarbon or hydrogen containing fuels. If desired, a reformer 17 may be located in the fuel processing module housing 16. Alternatively, if it is desirable to thermally integrate the reformer 17 with the electrochemical cell stack(s), then a separate reformer 17 may be located in each hotbox in a respective power module housing 12. Furthermore, if internally reforming electrochemical cells are used, then an external reformer 17 may be omitted entirely.

For electrolyzer cell systems, the fuel comprises steam which is electrolyzed into hydrogen and oxygen in the electrolyzer cell module 13 (FCM 13). In this case, the fuel processing module housing 16 may contain a steam generator and/or water purification components.

The modular electrochemical cell system enclosure 10 also contains one or more power conditioning module housings 18. The power conditioning module housing 18 includes a cabinet that contains at least one inverter for converting DC power generated by the FCM 13 to AC power for fuel cell systems or at least one rectifier that converts AC power to DC power, electrical connectors for AC power grid connection, circuits for managing electrical transients, and the system controller 19 (e.g., a computer or dedicated control logic device or circuit). Additionally, the power conditioning module housing 18 may contain an inverter redundant controller (IRC) that communicates with the system controller 19.

In some embodiments, memory associated with the IRC may store site-specific configuration settings, such as operating parameters, configuration data, and other settings required to meet utility requirements at the site of installation. During site commissioning, the system controller may communicate with the IRC to obtain site-specific electrical settings required for the system to connect to the utility grid. These settings, which may include voltage, frequency, and safety parameters, are stored within the memory associated with the IRC and retrieved by the system controller as needed. This method may reduce or eliminate the need for manual entry of site-specific settings, reducing human error and ensuring compliance with utility regulations.

The fuel processing module housing 16 and the power conditioning module housing 18 may be housed in one input/output cabinet 14. If a single input/output cabinet 14 is provided, then module housings 16 and 18 may be located vertically (e.g., power conditioning module housing 18 components above the fuel processing module 16 desulfurizer canisters/beds) or side by side in the cabinet 14. Each of the power module housings 12 and input/output modules 14 include a door 30 (e.g., hatch, access panel, etc.) to allow the internal components of the module to be accessed (e.g., for maintenance, repair, replacement, etc.).

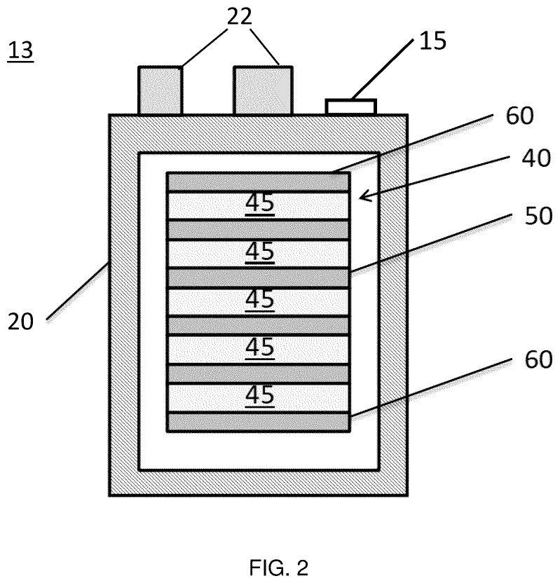

FIG. 2 illustrates a plan view of an electrochemical cell module or FCM 13 including one or more electrochemical cell stacks or columns 40. FIG. 2 schematically illustrates a hotbox 20 containing one electrochemical cell stack or column 40. The hotbox 20 may include two or more of the stacks or columns 40. The stack or column 40 may include the electrically connected electrochemical cells 45 (e.g., fuel cells or electrolyzer cells) stacked on one another, with interconnects 50 disposed between the electrochemical cells 45. The first and last electrochemical cells 45 in the stack or column are disposed between a respective end plate 60 and an interconnect 50. The end plates 60 are electrically connected to the electrical outputs of the electrochemical cell stack or column 40. The hotbox 20 may include other components, such as fuel conduits, air conduits, seals, electrical contacts, heat exchangers, catalysts, sensors, etc., and may be incorporated into the FCM 13 including the balance of plant components, such as blowers, etc. The electrochemical cells 45 may be solid oxide electrochemical cells containing a ceramic electrolyte, such as yttria-stabilized zirconia (YSZ) or scandia stabilized zirconia (SSZ), a fuel electrode, such as a nickel-YSZ, a Ni-SSZ or a nickel-samaria doped ceria (SDC) cermet, and an air electrode, such as lanthanum strontium manganite (LSM)). The interconnects 50 and/or end plates 60 may comprise any suitable gas impermeable and electrically conductive material, such as a chromium-iron alloy, such as an alloy containing 4 to 6 wt% iron and balance chromium, or stainless steel. The interconnects 50 electrically connect adjacent electrochemical cells 45 and provide channels for fuel and air to reach the electrochemical cells 45. The FCM 13 may also include the MVIO module 15 which is mounted outside the hotbox 20.

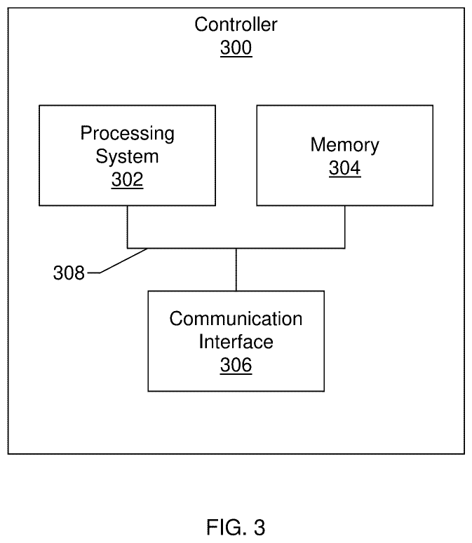

FIG. 3 illustrates an example of a controller 300 suitable for implementing various embodiments. With reference to FIGS. 1-3, the controller 300 (e.g., the combination of the system controller 19 and the MVIO module 15 in FIGS. 1 and 2) may include one or more processing systems 302, one or more memories 304, and one or more communication interfaces 306 connected via a communication bus 308.

The one or more processing systems 302 may refer to one or more processing devices, for example, one or more processors or one or more processor cores. The one or more processing systems 302 may include any of a variety of processing devices, for example, a number of processor cores. The one or more processing systems 302 may include a variety of different types of processors and processor cores, such as a general-purpose processor, a central processing unit (CPU), a digital signal processor (DSP), a secure processing unit (SPU), an artificial intelligence processing unit (AIPU), a subsystem processor of specific components of a system (e.g., module 13 in FIG. 1), an auxiliary processor, a single core processor, a multi-core processor, a controller, and a microcontroller. The one or more processing systems 302 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. The one or more processing systems 302 may include integrated circuits that may be configured such that the components of the integrated circuit reside on a single piece of semiconductor material, such as silicon. The one or more processing systems 302 may each be configured for specific purposes that may be the same as or different from other processing systems 302 of the system. One or more of the one or more processing systems 302 of the same or different configurations may be grouped together. A group of one or more processing systems 302 may be referred to as a multi-processor system cluster.

The one or more memories 304 may be a volatile or nonvolatile memory configured for storing data and processor system executable code for access by the one or more processing systems 302. The controller 300 may include one or more memories 304 configured for various purposes. The one or more memories 304 may include volatile memories such as random access memory (RAM) or main memory or cache memory. For example, the one or more memories 304 may include any of static RAM (SRAM), dynamic RAM (DRAM), etc. The one or more memories 304 may include nonvolatile memories such as storage memory. For example, the one or more memories 304 may include hard disk memory, solid state memory, read-only memory (e.g., erasable programmable read-only memory (EPROM) or electrically erasable programmable read-only memory (EEPROM)), etc. These one or more memories 304 may be configured to temporarily store a limited amount of data and/or processor system executable code instructions produced by the one or more processing systems 302 during operations. These one or more memories 304 may be configured to persistently store a limited amount of data and/or processor system executable code instructions that are preprogrammed and configured for access across various boot cycles.

The communication interface 306 may enable components of the controller 300, such as the one or more processor systems 302 and/or the one or more memories 304, to communicate with other components of the system (e.g., communication between the system controller 19 and MVIO module 15 in FIGS. 1 and 2, and/or communication between the system controller 19 and the remote central controller) via a communication network (e.g., communication network channel 11 in FIG. 1). The communication interface 306 may provide and manage physical and logical connections between the components of the controller 300 and the system. The communication interface 306 may also manage communication between the components of the controller 300 and the system, such as by directing and/or allowing communications between transmitter and receiver pairs of the components of the controller 300 and the system. The communications may include the transmission of memory access commands, addresses, data, interrupt signals, state signals, etc. In some embodiments, the communication interface 306 may implement one or more communication protocols, such as controller area network (CAN), peripheral component interconnect express (PCIe), etc.

The communication bus 308 may be a communication fabric configured to communicatively connect the components of the controller 300. The communication bus 308 may transmit signals between the components of the controller 300. In some embodiments, the communication bus 308 may be configured to control signals between the components of the controller 300 by controlling the timing and/or transmission paths of the signals.

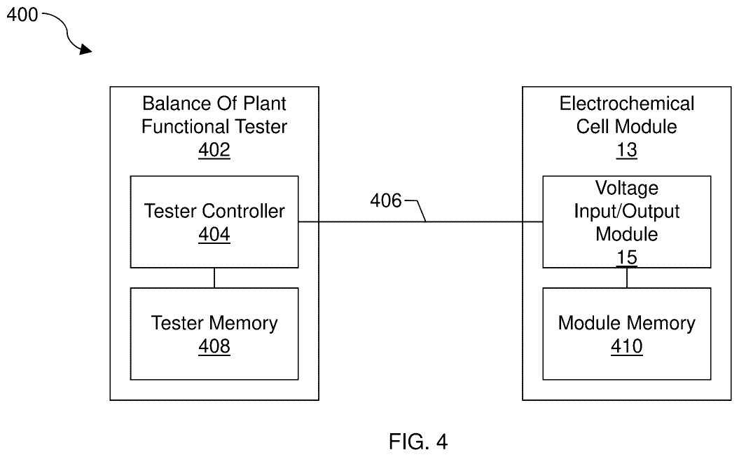

FIG. 4 illustrates an MVIO module configuration system 400 suitable for implementing various embodiments. With reference to FIGS. 1-4, the MVIO module 15 (e.g., controller 300 in FIG. 3) may be configured to store configuration data for the electrochemical cell module or FCM 13. A balance of plant (BOP) functional tester 402 may include a tester controller 404 that may be configured to identify the FCM 13, retrieve the configuration data for the FCM 13, and transmit the configuration data for the FCM 13 to the MVIO module 15. The tester controller 404 and the MVIO module 15 may be connected and may communicate over a CAN bus.

During post manufacturing testing of a FCM 13, the BOP functional tester 402 is used to test the operation of the BOP components of the FCM 13, such as blowers 20, valves, detectors, etc. During, before or after such testing, the tester controller 404 and the MVIO module 15 may be connected via the communication network bus 406. The tester controller 404 may receive an identifier of the FCM 13. For example, the identifier may be a top level SKE part number of the FCM 13. The identifier of the FCM 13 may be entered by an operator of the BOP functional tester 402 via an HMI (not shown) or may be read from an identifier marking on the FCM 13 via a sensor (not shown) of the BOP functional tester 402 connected to the tester controller 404. Based on the identifier of the FCM 13, the tester controller 404 may retrieve the configuration data for the FCM 13. The configuration data for the FCM 13 may be retrieved based on a relation of the identifier and the configuration data of the FCM 13 stored in a data structure. For example, the data structure may be stored in the tester memory 408 of the BOP functional tester 402 or a remote source (not shown), such as remote computing device or system, via a communication network (not shown), such as a local area network (LAN), wide local area network (WLAN), wide area network (WAN), the Internet, etc. The configuration data of the FCM 13 may be stored in the data structure or at a location indicated in the data structure in the tester memory 408 or the remote computing device or system.

The tester controller 404 may transmit the configuration data of the FCM 13 to the MVIO module 15 via the communication network bus 406. For example, the tester controller 404 may transmit a CAN data message to the MVIO module 15 having the configuration data of the FCM 13.

The MVIO module 15 may receive the configuration data of the FCM 13 from the tester controller 404 via the communication network bus 406. The MVIO module 15 may store the configuration data of the FCM 13 on a module memory 410 (e.g., memory 304 in FIG. 3) of the FCM 24. For example, the FCM memory 410 may be an integral component of the MVIO module 15.

In some embodiments, during transmission of the configuration data of the FCM 13, the tester controller 404 may implement error checking for the configuration data being transmitted via the communication network bus 406. For example, the tester controller 404 may implement a cyclical redundancy check (CRC) of the configuration data of the FCM 13 the tester controller 404 transmits. In response to detecting an error in the configuration data of the FCM 13 being transmitted, the tester controller 404 may implement error correction of the configuration data. For example, the tester controller 404 may retransmit the configuration data of the FCM 13, or error-corrected configuration data, to the MVIO module 15 via the communication network 406 in a manner similar to as described for the original transmission of the configuration data. The MVIO module 15 may receive and store the error corrected configuration data of the FCM 13 to the FCM memory 410 in a manner similar to as described for receiving and storing the configuration data of the original transmission. The tester controller 404 may also implement validation of the configuration data of the FCM 13 transmitted to the MVIO module 15.

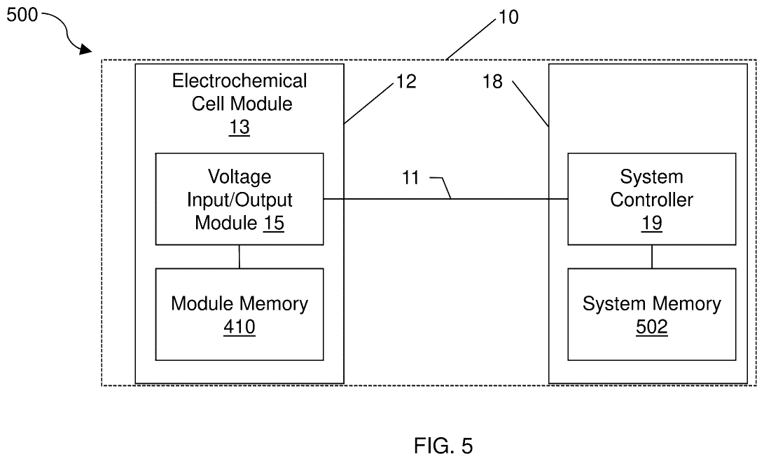

FIG. 5 illustrates an electrochemical cell system configuration system 500 suitable for implementing various embodiments. With reference to FIGS. 1-5, in the electrochemical cell system enclosure 10, the system controller 19 (e.g., controller 300 in FIG. 3) may be configured to load the configuration data for the FCM 13 from the MVIO module 15 of the FCM 13. The MVIO module 15, having the configuration data for the FCM 13 stored on the FCM memory 410 during manufacturing and testing of the FCM 13, may provide the configuration data to the system controller 19. The system controller 19 and the MVIO module 15 may be connected and may communicate via a wired or wireless communication network channel 11, such as a CAN bus.

The system controller 19 may request the configuration data for the FCM 13 from the MVIO module 15. For example, the system controller 19 may transmit a CAN remote message to the MVIO module 15. In some embodiments, the system controller 19 may request the configuration data for the FCM 13 in response to one or more conditions. For example, the conditions for requesting the configuration data for the FCM 13 from the MVIO module 15 by the system controller 19 may include completion of a power-up process of a power module (e.g., the FCM 13) located in housing 12. Alternatively or in addition, the conditions for requesting the configuration data for the FCM 13 from the MVIO module 15 by the system controller 19 may include the electrochemical cell system being stopped, including any of the following electrochemical cell system states: Stop, Commissioning Standby, Ready to Start, Interlocked, Commissioning Hold. The system controller 19 may establish a connection with the MVIO module 15 via the communication network channel 11 and transmit a request for the configuration data for the FCM 13 from the MVIO module 15 via the communication network channel 11 to the remote central controller.

The MVIO module 15 may receive the request for the configuration data for the FCM 13 from the system controller 19 via the communication network channel 11. The configuration data for the FCM 13 may be stored on and retrieved from the FCM memory 410 by the MVIO module 15. The MVIO module 15 may transmit the configuration data of the FCM 13 to the system controller 19 via the communication network channel 11. For example, the MVIO module 15 may transmit a CAN data message to the system controller 19 having the configuration data of the FCM 13.

The system controller 19 may receive the configuration data of the FCM 13 from the MVIO module 15 via the communication network channel 11. The system controller 19 may load the configuration data of the FCM 13 to apply correct operating parameters and control logic features, and ensure that the FCM 13 is operated correctly. For example, loading the configuration data of the FCM 13 may include storing the configuration data to a system memory 502 (e.g., memory 304 in FIG. 3) for access by the system controller 19 during operation of the FCM 13.

In some embodiments, loading the configuration data of the FCM 13 may be executed in response to validation of the configuration data by the system controller 19. For example, the configuration data of the FCM 13 may include or be transmitted with a validation indicator by the MVIO module 15. The validation indicator may be configured to indicate to the system controller 19 whether the configuration data of the FCM 13 is valid. Validity of the configuration data of the FCM 13 may be evaluated and the validation indicator may be set by the tester controller 404 in FIG. 4 and stored on the FCM memory 410 as part of or with the configuration data. The validation indicator may be retrieved from the FCM memory 410 and transmitted to the system controller 19 by the MVIO module 15 in response to the request for the configuration data of the FCM 13 from the system controller 19. In response to the validation indicator indicating to the system controller 19 that the configuration data of the FCM 13 is valid, the system controller 19 may load the configuration data. In response to the validation indicator indicating to the system controller 19 that the configuration data of the FCM 13 is not valid, the system controller 19 may retrieve and load configuration data of the FCM 13 previously stored on the system memory 502. The configuration data of the FCM 13 received from the MVIO module 15 may be referred to as external and the previously stored configuration data retrieved from the system memory 502 may be referred to as internal. Furthermore, the system controller 19 may transmit the configuration data of FCM 13 via a communication network channel to the remote central controller, and receive control instruction signals from the remote central controller. The system controller 19 then implements the control instructions (e.g., changing blower speed, changing one or more valve settings, changing the amount of electrical power drawn from a FCM 13 or changing the amount of electrical power provided to an electrolyzer FCM 13, etc.).

In some embodiments, other aspects of operating the electrochemical cell system may be updated by the system controller 19. For example, updated variable frequency drive (VFD) configurations or electrochemical cell system calibration parameters, such as water flow into the fuel cell fuel recycle stream control parameters, fuel mass flow controller (MFC) parameters, etc., may be updated. In fuel cell systems, the VFD converts the DC power from the fuel cell stack or column 40 to AC power with a variable frequency to control the speed of motors of the blowers 20 or other BOP components. The system controller 19 may synchronize the MVIO module 15 with the aspects of operating the electrochemical cell system by transmitting the aspects to the MVIO module 15 via the communication network channel 11. For example, the system controller 19 may transmit a CAN data message having the aspects of operating the electrochemical cell system to the MVIO module 15.

The MVIO module 15 may receive the aspects of operating the electrochemical cell system transmitted by the system controller 19 via the communication network channel 11. The MVIO module 15 may load the aspects of operating the electrochemical cell system to apply correct operating parameters and control logic features and ensure that the FCM 13 is operated correctly. For example, loading the aspects of operating the electrochemical cell system may include storing the aspects to the FCM memory 410 for access by the MVIO module 15 during operation of the FCM 13. The aspects of operating the electrochemical cell system may be transmitted by the system controller 19 to the remote central controller and then receiving control instruction signals from the remote central controller. The system controller 19 then implements the control instructions.

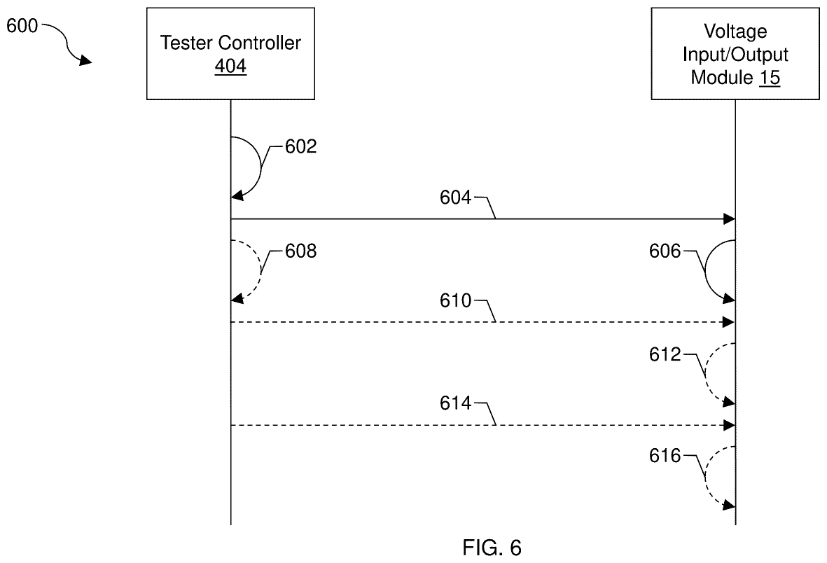

FIG. 6 illustrates an MVIO module configuration system 600 suitable for implementing various embodiments. With reference to FIGS. 1-6, the MVIO module configuration system 600 (e.g., MVIO module configuration system 400 in FIG. 4) may include the tester controller 404 and the MVIO module 15 connected via a communication network channel, such as a CAN bus. In process 602, the tester controller 404 may identify the FCM (e.g., the FCM 13 in FIGS. 1, 2, 4, and 5) and retrieve the configuration data for the FCM from the module memory 304 or from the tester memory 408 or from a remote source. In process 604, the tester controller 404 may transmit, and the MVIO module 15 may receive the configuration data for the FCM 13 via the communication network channel 11. For example, the tester controller 404 may transmit and the MVIO module 15 may receive a CAN data message having the configuration data for the FCM 13. In process 606, the MVIO module 15 may store the configuration data for the FCM 13 in the FCM memory 410.

In some embodiments, in process 608, the tester controller 404 may execute error detection and correction for the configuration data for the FCM. The tester controller 404 may execute error detection for the configuration data for the FCM being transmitted by the tester controller 404. In other words, the tester controller 404 may execute error detection for the configuration data for the FCM being transmitted concurrently with the tester controller 404 transmitting the configuration data. Identifying an error in the configuration data for the FCM may trigger the tester controller 404 to retransmit the configuration data for the FCM or transmit error-corrected configuration data for the FCM to the MVIO module 15 via the communication network in process 610. For example, the tester controller 404 may transmit a CAN data message having the error corrected configuration data for the FCM. The MVIO module 15 may receive the error-corrected configuration data for the FCM via the communication network, and, in process 612, the MVIO module 15 may store the error-corrected configuration data in the FCM memory. In some embodiments, the tester controller 404 may execute validation for the configuration data for the FCM.

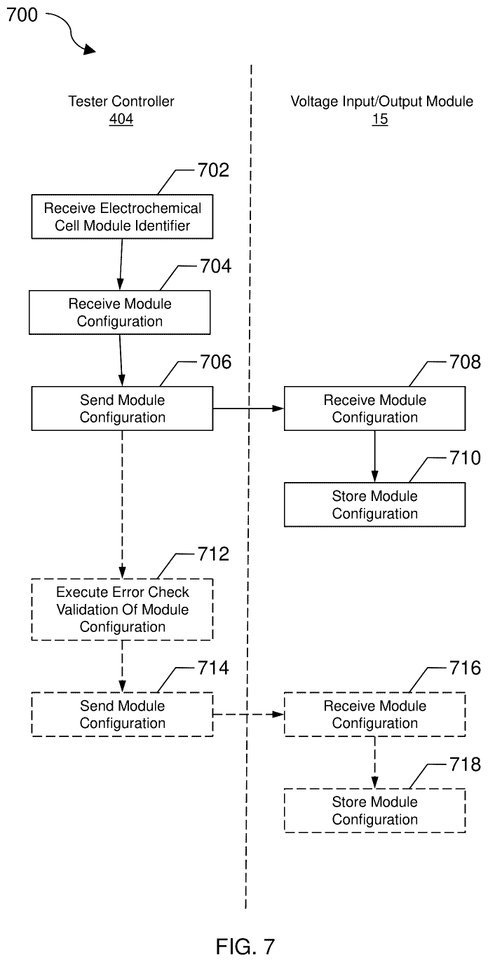

FIG. 7 illustrates a method 700 for configuring the MVIO module 15 according to various embodiments. The method 700 may be implemented using one or more processor systems (e.g., MVIO module 15, controller 300, processing system 302, and/or tester controller 404 in FIGS. 1-6) configured with hardware and/or firmware or software containing processor system executable instructions stored on a non-transient processor system readable medium (e.g., memory 304, tester memory 408, FCM memory 410 in FIGS. 3-5). The processor system executable instructions may be configured to cause the one or more processor systems to implement aspects of the method 700. The one or more processor systems may be components of one or more devices or systems (e.g., FCM 13, BOP functional tester 402 in FIGS. 1-5) and may be connected and configured to communicate via a communication network channel (e.g., communication network 406 in FIG. 4), such as a CAN bus. Aspects of method 700 may be implemented on one or more processor systems, hardware, firmware, software, one or more devices or systems. In order to encompass the alternative configurations, the hardware implementing the method 700 is referred to herein as a “tester processor system” or a “FCM processor system.”

In block 702, the tester processor system (e.g., the tester controllers 404) may receive an identifier for an FCM (e.g., FCM 13 in FIGS. 1, 2, 4, and 5). For example, the identifier may be a top level SKE part number of the FCM. The identifier of the FCM may be entered by an operator of the BOP functional tester 402 via an HMI or may be read from an identifier marking on the FCM via a sensor of the BOP functional tester 402.

In block 704, the tester processor system may receive FCM configuration data based on the identifier of the FCM. For example, the configuration data for the FCM may be received in response to a request for the configuration data from the tester processor system based on the identifier of the FCM. The tester processor system may request the configuration data for the FCM from a memory (e.g., tester memory 408 in FIGS. 3 and 4) of the BOP functional tester 402. The tester processor system may request the configuration data for the FCM from a remote source, such as a remote computing device or system, via a communication network, such as a LAN, WLAN, WAN, the Internet, etc.

In block 706, the tester processor system may send the configuration data for the FCM to the FCM processor system via the communication network channel. For example, the tester processor system may generate and transmit a message, such as a CAN data message, having the configuration data for the FCM.

In block 708, the MVIO module 15 may receive the configuration data for the FCM 13. For example, the MVIO module may receive a message, such as a CAN data message, having the configuration data for the FCM 13. In block 710, the MVIO module 15 may store the configuration data for the FCM in a memory (e.g., the FCM memory 410 in FIGS. 3-5) of the MVIO module 15.

In optional block 712, the tester processor system may execute an error check of the configuration data for the FCM 13. For example, the tester processor system may implement CRC of the configuration data of the FCM configuration data the tester processor system transmits. In some embodiments, the tester processor system may execute the error check of the configuration data for the FCM at the same time as transmitting the configuration data of the FCM in block 706.

In optional block 714, the tester processor system may send the configuration data for the FCM to the MVIO module 15. The tester processor system may send the configuration data for the FCM in response to detecting an error in the configuration data transmitted in block 706. Sending the configuration data for the FCM may be implemented in a similar manner to the manner described for block 706 and may be referred to as resending or retransmitting. Sending the configuration data for the FCM may also be referred to as sending or transmitting error-corrected configuration data for the FCM.

In block 716, the MVIO module 15 may receive the error-corrected configuration data for the FCM via the communication network channel. The MVIO module may receive the error corrected configuration data for the FCM in a manner similar to that described for receiving the configuration data for the FCM configuration data in block 708. In block 718, the MVIO module may store the error-corrected configuration data for the FCM in the memory of the MVIO module. For example, the MVIO module may overwrite the configuration data for the FCM in the memory with the error-corrected configuration data for the FCM. As another example, the MVIO module may invalidate, flush, erase, etc. the configuration data for the FCM in the memory.

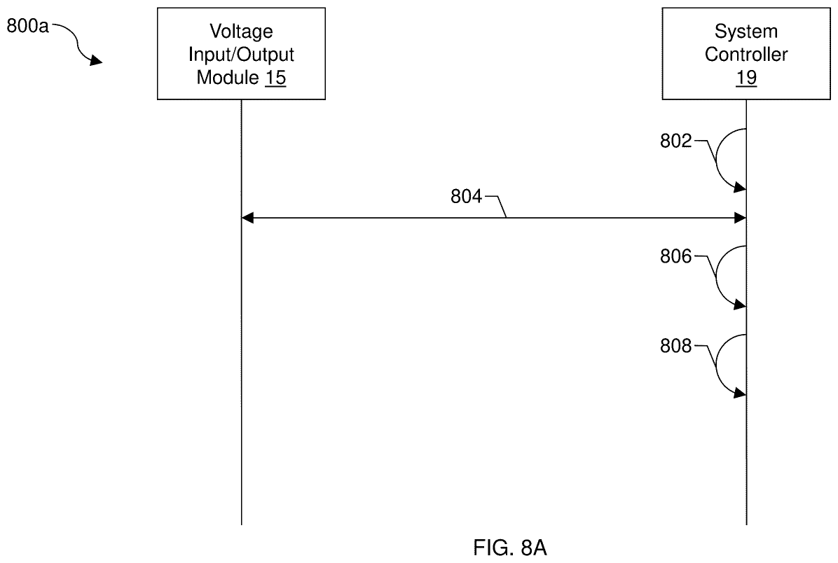

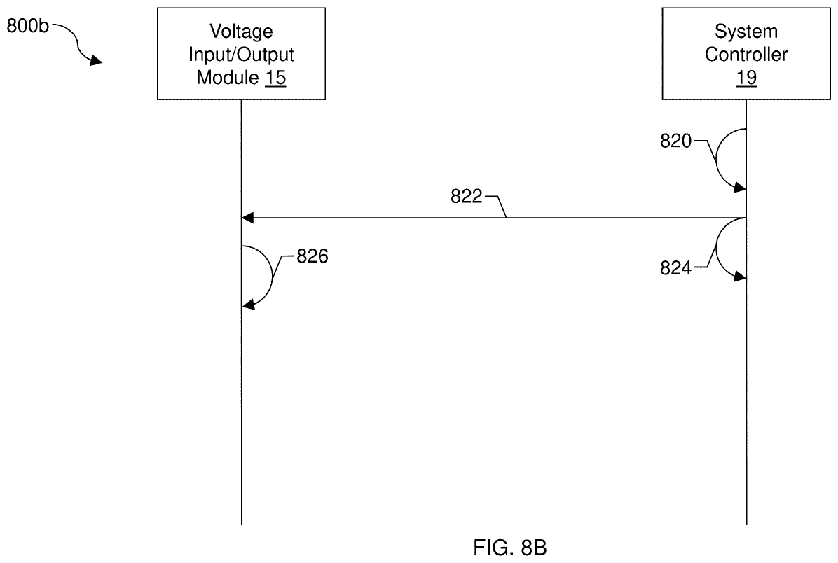

FIGS. 8A and 8B illustrate an electrochemical cell system controller configuration system 800a, 800b suitable for implementing various embodiments. With reference to FIGS. 1-8B, the electrochemical cell system controller configuration system 800a, 800b (e.g., electrochemical cell system controller configuration system 500 in FIG. 5) may include the MVIO module 15 and the system controller 19 connected via a communication network (e.g., communication network 11 in FIGS. 1 and 5), such as a CAN bus. In process 802, the system controller 19 may wait for a condition requesting the configuration data for the FCM. The condition for requesting the configuration data for the FCM may include completion of a power-up process of the FCM. Alternatively or in addition, the condition for requesting the configuration data for the FCM may include the electrochemical cell system being stopped, including any of the following electrochemical cell system states: Stop, Commissioning Standby, Ready to Start, Interlocked, Commissioning Hold.

In process 804, the system controller 19 may establish a connection with the MVIO module 15 via a communication network channel and transmit a request for the configuration data for the FCM 13 from the MVIO module 15. In response to the request for the configuration data for the FCM, the MVIO module 15 may retrieve the configuration data from memory (e.g., FCM memory 410 in FIGS. 3-5) of the MVIO module 15. The MVIO module 15 may transmit the configuration data for the FCM to the system controller 19 via a communication network channel. For example, the system controller 19 may request the configuration data for the FCM in a CAN remote message, and the MVIO module 15 may transmit the configuration data in a CAN data message. The system controller 19 may receive the configuration data for the FCM from the MVIO module 15 via the communication network channel.

In process 806, the system controller 19 may execute validation of the configuration data for the FCM received from the MVIO module 15. For example, the system controller 19 may check a validation indicator transmitted from the MVIO module 15 with the configuration data for the FCM and interpret whether the validation indicator indicates that the configuration is valid or not valid.

In process 808, the system controller 19 may load configuration data for the FCM. In response to the validation indicator indicating to the system controller 19 that the configuration data of the FCM is valid, the system controller 19 may load the configuration data received from the MVIO module 15 in process 804. In response to the validation indicator indicating to the system controller 19 that the configuration data of the FCM is not valid, the system controller 19 may retrieve and load configuration data of the FCM previously stored on system memory 502. The configuration data of the FCM received from the MVIO module 15 may be referred to as external and the previously stored configuration data retrieved from system memory may be referred to as internal.

In process 820 in FIG. 8B, the system controller 19 may receive updates for other operational aspects of the electrochemical cell system. For example, the system controller 19 may receive an updated variable frequency drive (VFD) configuration or electrochemical cell system calibration parameters, such as water flow rate into the fuel recycle stream, mass flow controller (MFC) parameters, etc. In process 822, the system controller 19 may transmit the updates for other aspects of operating the electrochemical cell system to the MVIO module 15 via the communication network channel. For example, the system controller 19 may transmit a CAN data message having the updates for other aspects of operating the electrochemical cell system to the MVIO module 15. In process 824, the system controller 19 may load the updates for other aspects of operating the electrochemical cell system. In some embodiments, the system controller 19 may transmit the updates for other aspects of operating the electrochemical cell system to the MVIO module 15 in process 822 and load the updates for other aspects of operating the electrochemical cell system in process 824 concurrently.

The MVIO module 15 may receive the other aspects of operating the electrochemical cell system transmitted by the system controller 19 via the communication network. In process 826, the MVIO module 15 may load the other aspects of operating the electrochemical cell system to apply correct operating parameters and control logic features and ensure that the FCM is operated correctly. For example, loading the other aspects of operating the electrochemical cell system may include storing the aspects to the memory of the FCM for access by the MVIO module 15 during operation of the FCM.

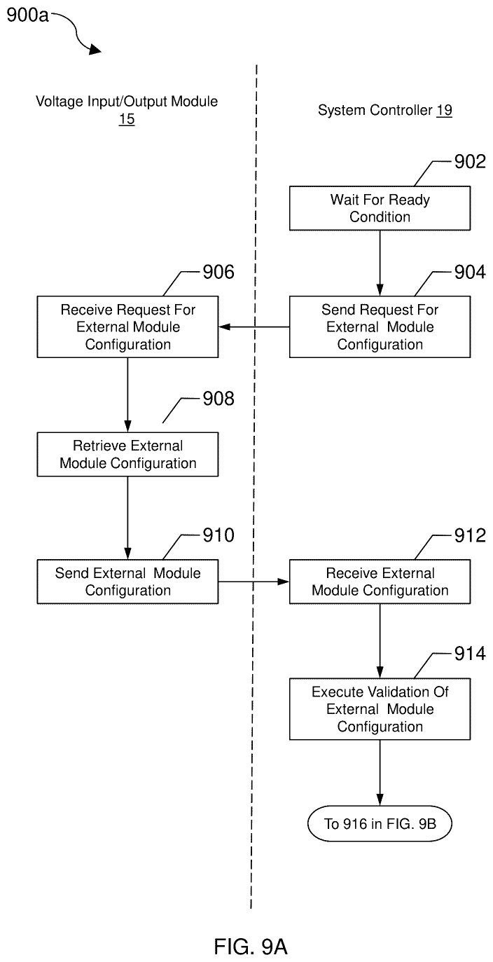

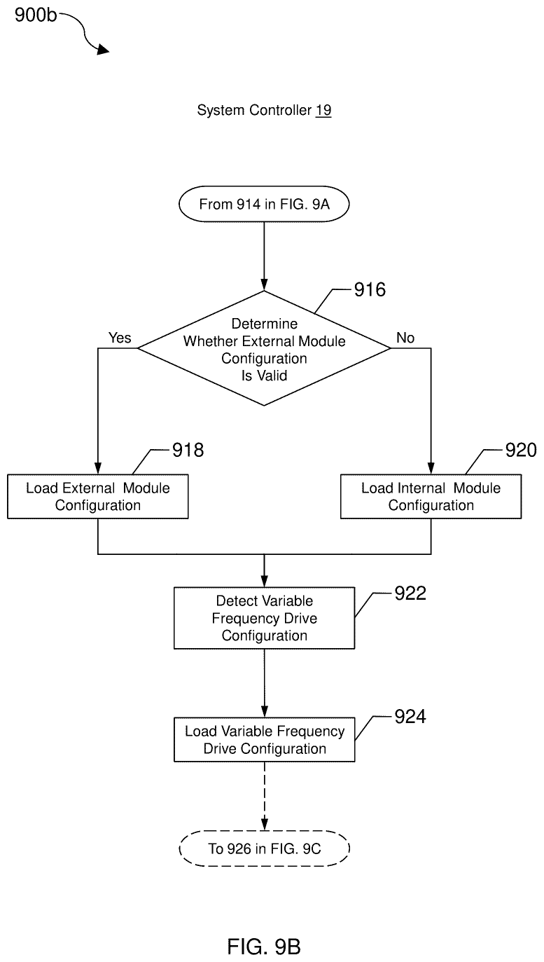

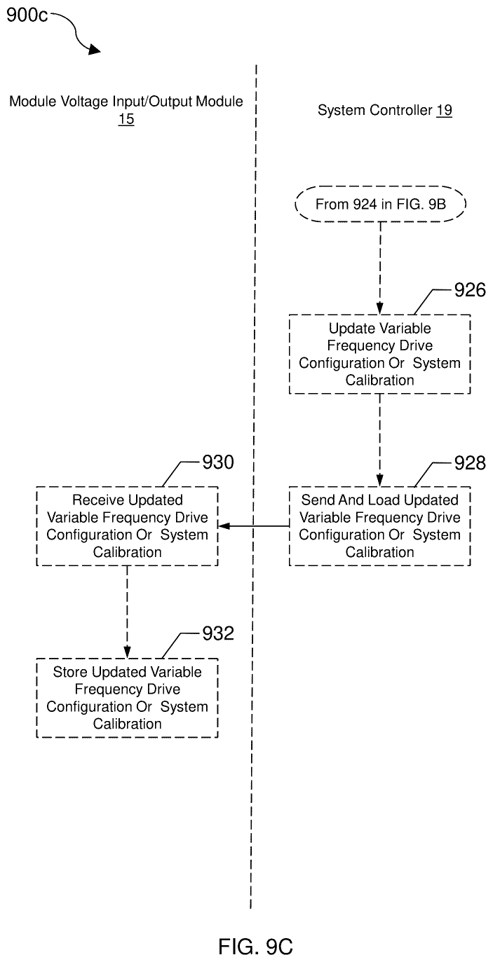

FIGS. 9A-9C are process flow diagrams of methods 900a, 900b, 900c for configuring an electrochemical cell system controller according to various embodiments. With reference to FIGS. 1-9C, the methods 900a, 900b, 900c may be implemented using one or more processor systems (e.g., MVIO module 15 and system controller 19) configured with hardware and/or firmware or software of processor system executable instructions stored on a non-transient processor system readable medium (FCM memory 410 and system memory 502). The processor system executable instructions may be configured to cause the one or more processor systems to implement aspects of the methods 900a, 900b, 900c. The one or more processor systems may be components of one or more devices or systems (e.g., FCM 13 or other devices within the electrochemical cell system enclosure 10 in FIGS. 1-5) and may be connected and configured to communicate via a communication network channel (e.g., communication network channel 11 in FIGS. 1 and 5), such as a CAN bus. The methods may be implemented using one or more processor systems, hardware, firmware, software, one or more devices or systems, or any other structure, material, or acts described herein and any equivalents thereof.

With reference to the method 900a and FIG. 9A, in block 902, the system controller 19 may wait for a ready condition. The ready condition may be a condition of the electrochemical cell system or the FCM 13 that may occur prior to the system controller 19 requesting the configuration data for the FCM from the MVIO module 15. For example, the ready condition may include completion of a power-up process of the FCM. Alternatively or in addition, the ready condition may include the electrochemical cell system being stopped, including any of the following electrochemical cell system states: Stop, Commissioning Standby, Ready to Start, Interlocked, Commissioning Hold.

In block 904, system controller 19 may send a request for configuration data for the FCM 13 from the MVIO module 15 via the communication network channel 11. For example, the request for the configuration data for the FCM may be a CAN remote message.

In block 906, the MVIO module 15 may receive the request for the configuration data for the FCM 13 via the communication network channel 11. In response to the request, the MVIO module may retrieve external configuration data for the FCM from a memory (e.g., the FCM memory 410 in FIGS. 3-5) of the MVIO module 15. The configuration data for the FCM may be referred to as the external configuration data for the FCM for configuration data stored in the memory of the MVIO module. In block 910, the MVIO module may send the external configuration data for the FCM to the system controller 19 via the communication network channel. For example, the FCM processor system may send a CAN data message having the external configuration data for the FCM.

In block 912, system controller 19 may receive the external configuration data for the FCM via the communication network. In block 914, system controller 19 may execute validation of the external configuration data for the FCM. For example, the external configuration data of the FCM may include or be transmitted with a validation indicator. The validation indicator may be configured to indicate to the system controller 19 whether the external configuration data of the FCM is valid. The system controller 19 may read and interpret the validation indicator for the external configuration data for the FCM.

With reference to the method 900b and FIG. 9B, in determination block 916, the system controller 19 may determine whether the external configuration data for the FCM is valid. In response to determining that the external configuration data for the FCM is valid (i.e., determination block 916=“Yes”), the system controller 19 may load the external configuration data for the FCM in block 918. The system controller 19 may load the external configuration data of the FCM to apply correct operating parameters and control logic features and ensure that the FCM is operated correctly. For example, loading the external configuration data of the FCM may include storing the external configuration data to a memory (e.g., system memory 502 in FIGS. 3 and 5) for access by system controller 19 for operation of the FCM.

In response to determining that the external configuration data for the FCM is not valid (i.e., determination block 916=“No”), the system controller 19 may load internal configuration data for the FCM in block 920. The system controller 19 may load the internal configuration data of the FCM to apply correct operating parameters and control logic features and ensure that the FCM is operated correctly. For example, loading the internal configuration data of the FCM may include retrieving the internal configuration data from the memory (e.g., system memory 502 or memory 304) of the system controller 19 for operation of the FCM.

In block 922, the system controller 19 may detect a VFD configuration. The system controller 19 may determine the VFD configuration, for example, based on a version of software or firmware for operating the VFD. In block 924, the system controller 19 may load the VFD configuration.

With reference to the method 900c and FIG. 9C, in optional block 926, the system controller 19 may update the VFD configuration or electrochemical cell system calibration parameters. For example, the system controller 19 may receive an updated VFD configuration or electrochemical cell system calibration parameters, such as fuel recycle stream water flow rate, mass flow controller (MFC) parameters, etc. For example, the updated VFD configuration may be due to an update to the firmware or software of the VFD or via a change of VFD configuration by an operator of the electrochemical cell system. As another example, the updated electrochemical cell system calibration parameters may be due to a change of electrochemical cell system calibration parameters by an operator of the electrochemical cell system or an automated process configured to manage the electrochemical cell system calibration parameters in response to one or more factors.

In optional block 928, the system controller 19 may transmit the updates for the VFD configuration or electrochemical cell system calibration parameters to the FCM MVIO module 15 via the communication network channel 11. For example, the system controller 19 may transmit a CAN data message having the updates for VFD configuration or electrochemical cell system calibration parameters to the FCM MVIO module 15.

In optional block 930, the MVIO module 15 may receive the updates for the VFD configuration or the electrochemical cell system calibration parameters. In optional block 932, the MVIO module 15 may store the VFD configuration or the electrochemical cell system calibration parameters in the memory of the MVIO module.

In various embodiments, the CAN messages may include fields containing configuration data for the FCM 13. The configuration data may include, but is not limited to, the model and/or part number of the FCM 13, the size of the electrochemical cell stacks or columns in the module 13, the number of the electrochemical cell stacks or columns in the FCM 13, the types of electrochemical cells and/or interconnects in the stacks or columns, the type of anode tail gas oxidizer in a FCM 13, the types of BOP components in the FCM 13 (e.g., types of valves and/or blowers), the VFD types and settings, the presence or absence of a low temperature oxidizer catalyst in the FCM 13 exhaust paths, the lifecycle or lifespan of the FCM 13, the fuel mass flow controller or valve calibration parameters, the water recycle controller or valve calibration parameters, the type of air flow meter in the FCM 13, etc.

To recap, various embodiments may include methods for configuring an electrochemical cell system performed by a system controller of the electrochemical cell system, which may include retrieving FCM configuration data from a memory based on an FCM identifier, and sending the first FCM configuration data via a communication channel to a MVIO module of an FCM. In some embodiments, the FCM configuration data corresponding with an FCM identifier may be received from a balance of plant (BOP) functional tester, and stored to a memory of the MVIO module.

Some embodiments may include executing error detection on the FCM configuration data being sent to the MVIO module, and sending error-corrected FCM configuration data to the MVIO module in response to detecting an error in the first FCM configuration data being sent to the MVIO module. Some embodiments may further include receiving error-corrected FCM configuration data based on the detection of an error in the first FCM configuration data via an error correction process of the balance of plant functional tester, and storing the error-corrected FCM configuration data to the memory of the MVIO module.

Various embodiments may include a method for configuring an electrochemical cell system performed by a system controller in communication with MVIO modules of one or more FCMs. Some embodiments may include receiving a request for FCM configuration data from a system controller, retrieving the FCM configuration data from a memory of the MVIO module, and sending the FCM configuration data to the system controller.

In some embodiments, receiving the request for the FCM configuration data from the system controller may include receiving the request for the FCM configuration data via a CAN message, and sending the FCM configuration data to the system controller may include sending the FCM configuration data via a CAN message.

Some embodiments may further include receiving updated variable frequency drive configuration data from the system controller for a variable frequency drive of the FCM, and storing the updated variable frequency drive configuration data to the memory of the MVIO module. Some embodiments may further include receiving updated electrochemical cell system calibration data from the system controller, and storing the updated electrochemical cell system calibration data to the memory of the MVIO module.

Various embodiments may include a method for configuring an electrochemical cell system performed by system controller of the electrochemical cell system. Some embodiments may include sending a request for a first FCM configuration data to a MVIO module of a FCM, receiving the first FCM configuration data from the MVIO module, and executing validation for the first FCM configuration data.

Some embodiments may further include loading the first FCM configuration data in response to determining that the first FCM configuration data is valid. Some embodiments may further include loading a second FCM configuration data from a memory of the system controller in response to determining that the first FCM configuration data from the MVIO module is not valid.

Some embodiments may further include updating a variable frequency drive configuration data for a variable frequency drive of a FCM, and sending the updated variable frequency drive configuration data to the MVIO module. Some embodiments may further include updating an electrochemical cell system calibration data from the system controller, and sending the updated electrochemical cell system calibration data to the MVIO module.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

The foregoing method descriptions and diagrams are provided merely as illustrative examples and are not intended to require or imply that the steps of the various embodiments must be performed in the order presented. As will be appreciated by one of skill in the art, the order of steps in the foregoing embodiments may be performed in any order. Further, words such as “thereafter,” “then,” “next,” etc. are not intended to limit the order of the steps; these words are simply used to guide the reader through the description of the methods.

One or more diagrams have been used to describe exemplary embodiments. The use of diagrams is not meant to be limiting with respect to the order of operations performed. The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

Control elements, including the control device as well as controllers 15, 19, 300, 404, described herein, may be implemented using computing devices (such as computer) that include programmable processors, memory and other components that have been programmed with instructions to perform specific functions or may be implemented in processors designed to perform the specified functions. A processor may be any programmable microprocessor, microcomputer or multiple processor chip or chips that can be configured by software instructions (applications) to perform a variety of functions, including the functions of the various embodiments described herein. In some computing devices, multiple processors may be provided. Typically, software applications may be stored in the internal memory before they are accessed and loaded into the processor. In some computing devices, the processor may include internal memory sufficient to store the application software instructions.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a control device that may be or include a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

The preceding description of the disclosed embodiments is provided to enable any person skilled in the art to make or use any of the described embodiments. Various modifications to these embodiments will be readily apparent to those skilled in the art, and the generic principles defined herein may be applied to other embodiments without departing from the scope of the disclosure. Thus, the claims are not intended to be limited to the embodiments shown herein but are to be accorded the widest scope consistent with the claim language and the principles and novel features disclosed herein.

1. A method for configuring an electrochemical fuel cell system performed by a processor, comprising:
retrieving first fuel cell module (FCM) configuration data from a memory based on a FCM identifier; and
sending first FCM configuration data to a module voltage input/output (MVIO) module of a FCM corresponding with the FCM identifier.

2. The method of claim 1, wherein the FCM identifier is a top level part number of the FCM.

3. The method of claim 1, wherein the sending the first FCM configuration data to the MVIO module of the FCM corresponding with the FCM identifier comprises sending the first FCM configuration data over a fieldbus.

4. The method of claim 1, further comprising:
executing error detection for the first FCM configuration data being sent to the MVIO module of the FCM; and
sending error corrected FCM configuration data to the MVIO module in response to detecting an error in the first FCM configuration data being sent to the MVIO module of the FCM.

5. The method of claim 1, wherein the FCM comprises a FCM for generating electricity or an electrolyzer FCM for producing hydrogen, wherein the FCM comprises at least one cell stack or column located in a hotbox and balance of plant components, and wherein the MVIO module is located outside the hotbox.

6. A method for configuring an electrochemical cell system performed by a processor system communicating with a module voltage input/output (MVIO) module of a fuel cell module (FCM), comprising:
receiving first FCM configuration data corresponding with an FCM identifier of the FCM from a balance of plant functional tester; and
storing the first FCM configuration data to a memory of the MVIO module.

7. The method of claim 6, wherein the FCM identifier represents a top level stack enclosure (SKE) part number of the FCM.

8. The method of claim 6, wherein receiving the first FCM configuration data corresponding with the FCM identifier of the FCM from the balance of plant functional tester comprises receiving the first FCM configuration data via a fieldbus message.

9. The method of claim 6, further comprising:
receiving error corrected FCM configuration data based on detection of an error in the first FCM configuration data via an error correction process of the balance of plant functional tester; and
storing the error corrected FCM configuration data to the memory of the MVIO module.

10. The method of claim 6, further comprising:
receiving a request for the first FCM configuration data from a system controller of the electrochemical cell system;
retrieving the first FCM configuration data from the memory of the MVIO module; and
sending the first FCM configuration data to the system controller.

11. The method of claim 6, wherein the FCM comprises a FCM for generating electricity or an electrolyzer FCM for producing hydrogen, wherein the FCM comprises at least one cell stack or column located in a hotbox and balance of plant components, and wherein the MVIO module is located outside the hotbox.

12. A method for configuring an electrochemical cell system performed by a system controller of the electrochemical cell system that communicates with a module voltage input/output (MVIO) module of a fuel cell module (FCM), comprising:
receiving a request for first FCM configuration data stored on the MVIO module from the system controller;
retrieving the first FCM configuration data from a memory of the MVIO module; and
sending the first FCM configuration data to the system controller.

13. The method of claim 12, wherein:
receiving the request for the first FCM configuration data from the system controller comprises receiving the request for the first FCM configuration data via fieldbus message; and
sending the first FCM configuration data to the system controller comprises sending the first FCM configuration data via a fieldbus message.

14. The method of claim 12, further comprising:
receiving, at the MVIO module, updated variable frequency drive configuration data from the system controller for a variable frequency drive of the FCM; and
storing the updated variable frequency drive configuration data to the memory of the MVIO module.

15. The method of claim 12, further comprising:
receiving, at the MVIO module, an updated electrochemical cell system calibration data from the system controller; and
storing the updated electrochemical cell system calibration data to the memory of the MVIO module.

16. The method of claim 12, wherein the system controller further validates the first FCM configuration data.

17. The method of claim 16, wherein the system controller further loads the first FCM configuration data in response to determining that the first FCM configuration data is valid.

18. The method of claim 16, wherein the system controller further loads different FCM configuration data from a different memory location in response to determining that the first FCM configuration data is not valid.

19. The method of claim 1, wherein retrieving the first FCM configuration data from a memory comprises retrieving the first FCM configuration data from a balance of plant functional tester; and
storing the first FCM configuration data to the memory of the MVIO module.

20. The method of claim 12, wherein the FCM comprises a FCM for generating electricity or an electrolyzer FCM for producing hydrogen, wherein the FCM comprises at least one cell stack or column located in a hotbox and balance of plant components, and wherein the MVIO module is located outside the hotbox.
